(19) United States
(12) Patent Application Publication
(10) Pub. No.: US 2009/0143913 A1
(43) Pub. Date: Jun. 4, 2009

(54) IMAGE-BASED SELF-DIAGNOSIS APPARATUS AND METHOD FOR ROBOT

(76) Inventors: Ki Beom KIM, Seoul (KR); Je Han Yoon, Seongnam-si (KR); Young Hee Park, Seoul (KR)

Correspondence Address: CHA & REITER, LLC, 210 ROUTE 4 EAST STE 103, PARAMUS, NJ, 07652, US

(21) Appl. No.: 12/260,290

(22) Filed: Oct. 29, 2008

(30) Foreign Application Priority Data
Oct. 29, 2007 (KR) 2007-0108733

(51) Int. Cl. G05B 19/00; G01C 21/00

(52) U.S. Cl. 700/259; 701/213

(57) ABSTRACT

An image-based self-diagnosis apparatus and method for a robot determines the abnormality of a driving unit of a mobile robot by using a camera and reporting to the user in real time. The image-based self-diagnosis method may include: capturing a reference image at the current location and storing the captured reference image; capturing a comparison image after making at least one of linear moves and rotational moves by a preset amount, and storing the captured comparison image; and determining the abnormality of the mobile robot by comparing the stored reference image and the comparison image with each other.

### CLAIM OF PRIORITY

This application claims priority under 35 U.S.C. §119 from an application entitled “IMAGE-BASED SELF-DIAGNOSIS APPARATUS AND METHOD FOR ROBOT” filed in the Korean Intellectual Property Office on Oct. 29, 2007 and assigned Serial No. 2007-0108733, the contents of which are incorporated herein by reference in its entirety.

### BACKGROUND OF THE INVENTION

1. Field of the Invention

The present invention relates generally to self-diagnosis of a mobile robot. More particularly, the present invention relates to an image-based self-diagnosis apparatus and method for a mobile robot for diagnosing the operation of the mobile robot by analyzing the difference between a reference image and a comparison image captured by a camera being a part of the mobile robot and sending the diagnosis result through a wireless communication to a remote control device, enabling the user to be aware of the status of the mobile robot.

2. Description of the Related Art

A mobile robot is a robot that can autonomously travel using, for example, a wheel or human leg-shaped driving unit. Mobile robots can be roughly classified into (1) intelligent robots using artificial intelligence, and (2) remote-controlled robots. Use of mobile robots is expected to rapidly grow in the future because such device can perform search, patrol, surveillance, and monitoring, thereby acting as a substitute for humans in environments where it is difficult for humans to work or dangerous to human lives, such as regions affected by a natural disaster or military dispute. Currently there are some versions of cleaning robots, errand robots and pet-dog robots, which are examples of mobile robots are already seen in daily lives of some people.

However, one of the drawbacks of the current mobile robots is that users have to check the operating status of mobile robots and manage them from time to time. For example, a cleaning robot might run out of cleaning material, get stuck under a piece of furniture or fall over down stairs, etc. Therefore, it is necessary to develop a self-diagnosis apparatus and method that enables a mobile robot to check the normality of itself.

An abnormality detection technique for a bi-ped mobile robot has been developed as part of an effort to provide a self-diagnosis feature for a mobile robot. In the abnormality detection technique, the bi-ped mobile robot performs self-diagnosis using driving units and internal sensors to check whether an abnormality is present in internal state quantities or in the internal sensors, and outputs and records, if an abnormality is detected, the abnormality and its occurrence time and date in internal and external memory units. In other words, when an abnormality is detected, the posture information and state quantities at the time of detection are recorded, and causes or processes leading to the abnormality are investigated.

The aforementioned abnormality detection technique has been developed for a humanoid mobile robot having a six-joint leg link, six-joint arm link, and one-joint head part. This humanoid mobile robot includes one or more electric motors for each joint, and a plurality of detection sensors to detect external forces exerted thereto. The abnormality detection apparatus records signals from the electric motors and internal sensors to perform self-diagnosis on the occurrence of a malfunction of the mobile robot. However, because robot abnormality is determined using abnormality determination of a driving unit, a heavy hardware burden may result depending upon the number of motors used in the driving unit. In addition, output signals from the driving motors and sensors are sequentially recorded together with their occurrence times and dates, causing a burden on storage capacity and software processing.

### SUMMARY OF THE INVENTION

The present invention has been made in part to provide an image-based self-diagnosis apparatus and method for a mobile robot that can check the abnormality of the mobile robot by using a camera that is a part of the mobile robot.

The present invention also provides an image-based self-diagnosis apparatus and method for a mobile robot, wherein for self-failure diagnosis, there is no requirement for additional hardware elements, as information to be collected is restricted to images captured by a camera, thereby reducing hardware and software burden.

In accordance with an exemplary embodiment of the present invention, there is provided an image-based self-diagnosis apparatus for a mobile robot, including: a driving unit making a linear move and rotational move; a camera unit capturing visual images; a memory unit storing visual images captured by the camera unit; and a control unit capturing a reference image at a current location through the camera unit, capturing a comparison image after controlling the driving unit to make at least one of linear moves and rotational moves by a preset amount, storing the captured reference and comparison images in the memory unit, and determining the abnormality of the mobile robot by comparing the stored reference image captured before the moves and the comparison image captured after the moves.

In accordance with another exemplary embodiment of the present invention, there is provided an image-based self-diagnosis method for a mobile robot, including: capturing a reference image at the current location and storing the captured reference image; capturing a comparison image after making at least one of linear moves and rotational moves by a preset amount, and storing the captured comparison image; and determining the abnormality of the mobile robot by comparing the stored reference image and the comparison image with each other.

In an exemplary feature of the present invention, a failure of a mobile robot can be indirectly localized without direct diagnosis of a hardware element, triggering further diagnosis of the failure. In addition, one of the many advantages of the present invention is that as no additional hardware element is required, image-based self-diagnosis can be performed for a mobile robot with reduced hardware and software burdens.

### BRIEF DESCRIPTION OF THE DRAWINGS

The objects, features and advantages of the present invention will be more apparent from the following detailed description in conjunction with the accompanying drawings, in which:

FIG. 1 is a diagram illustrating an example of the overall shape of a mobile robot in accordance with the principles of the present invention;

FIG. 2 is a functional block diagram of the mobile robot in FIG. 1 with an image-based self-diagnosis function according to an exemplary embodiment of the present invention;

FIG. 3 is a diagram illustrating an exemplary procedure for normality diagnosis on the linear motion of a wheel driving unit;

FIG. 4 is a diagram illustrating an exemplary procedure for normality diagnosis on the rotational motion of a wheel driving unit and motor unit; and

FIG. 5 is a flow chart illustrating an image-based self-diagnosis method for a mobile robot according to another exemplary embodiment of the present invention.

### DETAILED DESCRIPTION

Hereinafter, exemplary embodiments of the present invention are described in detail with reference to the accompanying drawings, which have been provided for illustrative purposes and do not limit the image-based self-diagnosis apparatus and method for a mobile robot to the examples shown and described herein. The same reference symbols identify the same or corresponding elements in the drawings. Detailed descriptions of constructions or processes known in the art may be omitted to avoid obscuring appreciation of the invention by a person of ordinary skill in the art with unnecessary detail regarding such known constructions or processes. Particular terms may be defined to describe the invention in the best manner. Accordingly, the meaning of specific terms or words used in the specification and the claims should not be limited to the literal or commonly employed sense, but should be construed in accordance with the spirit of the invention. The description of the various exemplary embodiments is to be construed as exemplary only and does not describe every possible instance of the invention. Therefore, it should be understood that various changes may be made and equivalents may be substituted for elements of the invention.

In the description, a “reference image” typically denotes an image that is captured by the mobile robot and used as a reference in checking the abnormality of a driving unit. A first reference image denotes an image that is typically captured by the mobile robot in a stationary state using the camera to diagnose linear motion of the wheel driving unit. A second reference image denotes an image that is captured by the mobile robot at a preset angle during rotational motion to diagnose rotational motion of the wheel driving unit and motor unit.

A “comparison image” denotes an image that is captured by the mobile robot after making a linear move or rotational move and is compared with the reference image.

“Reference data” typically refers to a table of data elements describing a change in the reference image between before and after a linear move or rotational move of the mobile robot. For example, for linear motion, reference data can be an enlargement or reduction ratio between a target object in the reference image before a linear move and that in the comparison image after the linear move. For rotational motion, reference data can be parameter values used to determine the adequacy of an image change between a reference image taken in one direction and a comparison image taken in another direction.

A “remote control device” typically comprises an appliance enabling data transmission and reception for communication between the user and mobile robot, and may be any informational and communication appliance or multimedia appliance, such as a network server, mobile communication terminal, mobile phone, personal digital assistant (PDA), smart phone, international mobile telecommunications 2000 (IMT 2000) terminal, universal mobile telecommunications system (UMTS) terminal, and digital broadcast receiving terminal, just to name a few non-limiting examples of such devices.

In the description of an image-based self-diagnosis apparatus and method for a mobile robot according to an exemplary embodiment of the present invention, it is assumed that the mobile robot is typically designed to include a wheel driving unit made of a wheel, and a camera installed at a head part that can be rotated by a motor.

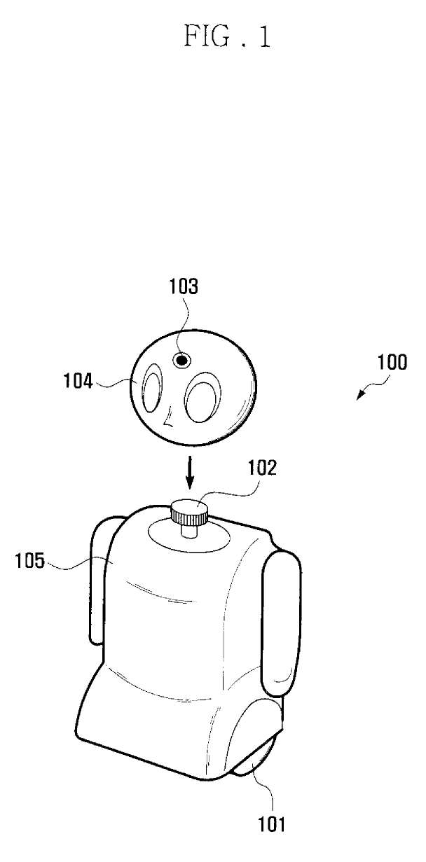

FIG. 1 is a diagram illustrating the overall shape of a mobile robot 100 as a target for an image-based self-diagnosis apparatus and method according to an exemplary embodiment of the present invention.

Referring to FIG. 1, the mobile robot 100, as a whole, includes a body part 105 and head part 104.

The body part 105 can include, for example, a wheel driving unit 101 at the lower base for providing the linear motion and rotational motion of the mobile robot 100. The wheel driving unit 101 can be formed using various types of elements such as a circular wheel, a belt wheel, and one or more legs. The wheel unit may be adapted for the type of terrain in which the mobile-robot is envisioned to operate, for example, sandy terrain, mud, pavement, packed soil, amphibious, etc.

The head part 104 can include a camera unit 103 to take a picture. A person of ordinary skill in the art understands and appreciates that the head may also comprise any shape other shown in FIG. 1. The camera unit 103 may be installed at the body part 105 depending upon the design. However, it is more preferable to install the camera unit 103 at the head part 104 for a mobile robot according to the present exemplary embodiment. A motor unit 102 can be installed at the interface between the body part 105 and head part 104 so as to rotate the head part 104. The motor unit 102 may be designed to perform not only rotational motion but also vertical (up/down) motion and even some lateral motion (side to side or front to back).

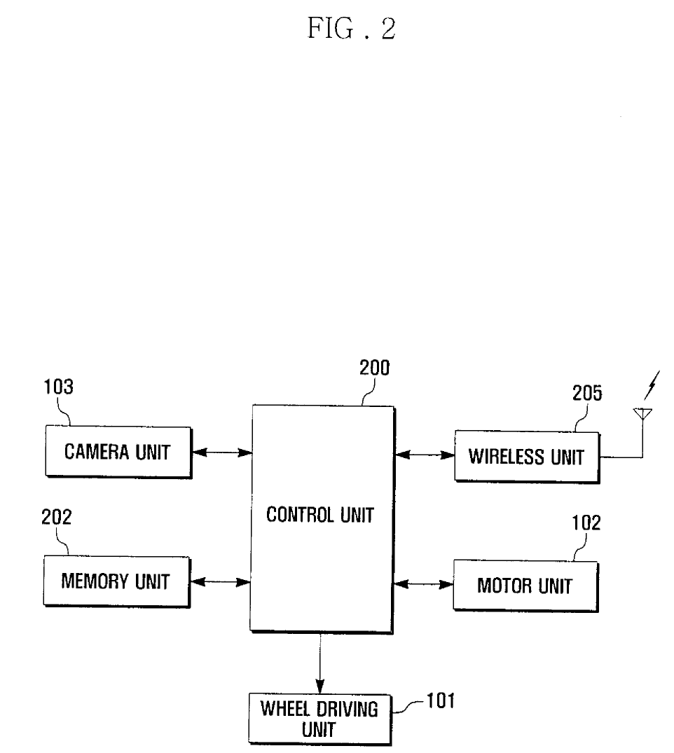

FIG. 2 is a functional block diagram of the mobile robot 100 shown in FIG. 1 according to an exemplary embodiment of the present invention.

Referring to FIG. 2, the mobile robot 100 typically includes a camera unit 103 for capturing reference and comparison images, a memory unit 202 for storing reference and comparison images, a control unit 200 for determining the abnormality of the mobile robot 100 by comparing a reference image and comparison image with each other and creating a self-diagnosis message, a wireless unit 205 for transmitting a self-diagnosis message depending upon the presence of abnormality, a wheel driving unit 101 for moving the mobile robot 100 linearly or rotationally, and a motor unit 102 for rotating the head part. Next, each component is described in detail.

The camera unit 103 may capture a visual image continuously or intermittently. The camera unit 103 can periodically capture a reference image or a comparison image according to a command from the user or a command programmed in the memory unit 202, and send the captured image or comparison image to the memory unit 202.

For example, a visual image captured by the camera unit 103 can be transmitted through the wireless unit 205 to a remote control device, which enables the user to view the image from the wireless unit 205 in real-time on the Web through a networked Web server. Particularly, during the self-diagnosis mode, the camera unit 103 can check the image capturing condition under the control of the control unit 200. The procedure to check the image capturing condition may include checking whether the current lighting level is adequate to permit taking distinguishable images, and/or checking whether the current location permits taking images in various directions, and a step of moving, if the current lighting level or current location is determined to be inadequate, the mobile robot 100 to a different location.

It is also within the spirit and scope of the invention that there may be a range of lighting levels wherein as one level is deemed to be adequate lighting, there may be a more preferable level, and the aforementioned actions may include moving the mobile robot to provide an improved lighting level. A person of ordinary skill in the art understands and appreciates that in addition to ambient lighting, the mobile robot may provide additional lighting to supplement the ambient lighting, in addition to or in lieu of moving the robot.

Still referring to FIG. 2, the memory unit 202 can store boot and initialization information for booting the system of the mobile robot 100, and various data.

For example, the memory unit 202 can store a difference image processing algorithm to analyze the difference between a reference image and comparison image, and a smoothing algorithm to handle a blob created at boundaries such as edges after difference image creation. The memory unit 202 can store reference data for linear motion related to an enlargement or reduction ratio of a comparison image after a linear move made by the wheel driving unit 101 and motor unit 102, and reference data for rotational motion used to determine the adequacy of an image change between a reference image taken in one direction and a comparison image taken in another direction. In addition, the memory unit 202 may store information regarding location and direction of a reference image captured in relation to a rotational move made by the wheel driving unit 101 and motor unit 102, as well as various data collected by the mobile robot 100, and data received through the wireless unit 205.

The memory unit 202 may include, for example a read only memory (ROM), flash memory, and random access memory, which may be provided as separate entities or as one or more combined entities. A person of ordinary skill in the art understands and appreciates that the present invention is not limited to the aforementioned exemplary memories.

The wheel driving unit 101 acts as a driving unit for moving the mobile robot 100, and generates and delivers power for linear motion and rotational motion. As described before, the wheel driving unit 101 can be formed using various types of elements such as a circular wheel, a belt wheel, and multiple legs. For a mobile robot designed for an amphibious environment, paddles or even air pressure can be used to move the robot until it reaches ground suitable for wheels, belt wheels, or circular legs.

The motor unit 102 rotates the head part 104, and generates and delivers power so that the head part can be rotated 360 degrees or any degrees according to the design. In addition, the motor unit 102 may be designed so as to move the head part 104 up and down.

In addition, a failure in the wheel driving unit 101 and motor unit 102 can affect images captured by the camera unit 103. In other words, the present invention provides an image-based self-diagnosis apparatus and method wherein changes in images captured by the camera unit 103 owing to the malfunction of the wheel driving unit 101 and/or motor unit 102 are checked to identify a failure of the mobile robot 100.

The wireless unit 205 communicates with a remote control device (not shown) to receive a command from the user and to send various information from the mobile robot 100 to the user. In particular when the control unit 200 performs self-diagnosis for failure identification, the wireless unit 205 sends the diagnosis result in real-time to the remote control device. The wireless unit 205 can send visual images captured by the camera unit 103 to the remote control device, and send, in response to a user command or for backup, various information stored in the memory unit 202 thereto.

The control unit 200 typically controls the overall operation of the mobile robot 100, and signal flows between the internal elements thereof. That is, the control unit 200 controls signal flows between the elements including the camera unit 103, memory unit 202, wheel driving unit 101, is motor unit 102 and wireless unit 205, according to an embodiment of the present invention. During the self-diagnosis mode, the control unit 200 can check the abnormality of the mobile robot 100 on the basis of reference and comparison images captured by the camera unit 103, and store the identified abnormality in the memory unit 202 or send the diagnosis result through the wireless unit 205 to the remote control device.

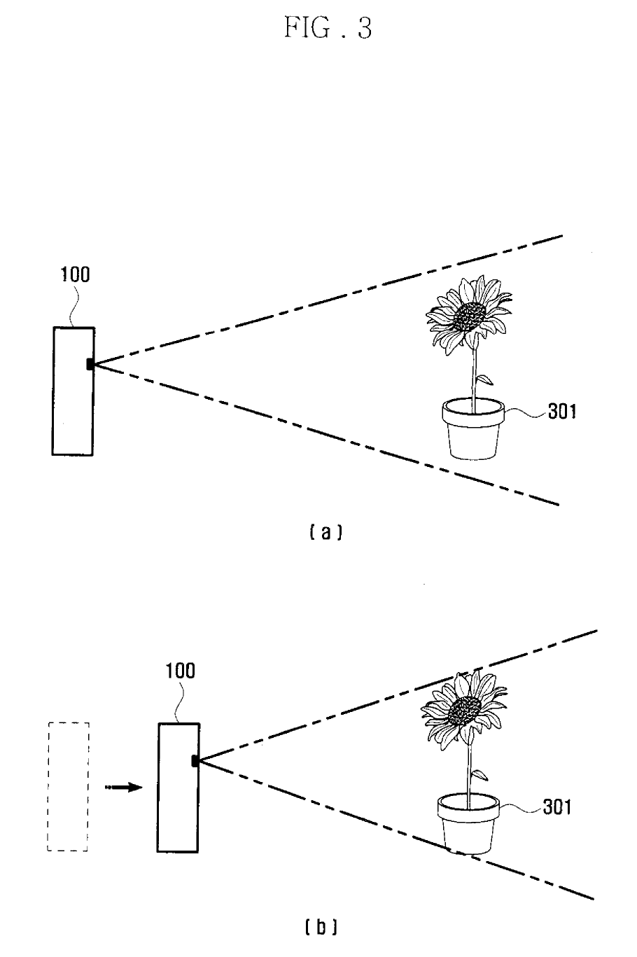

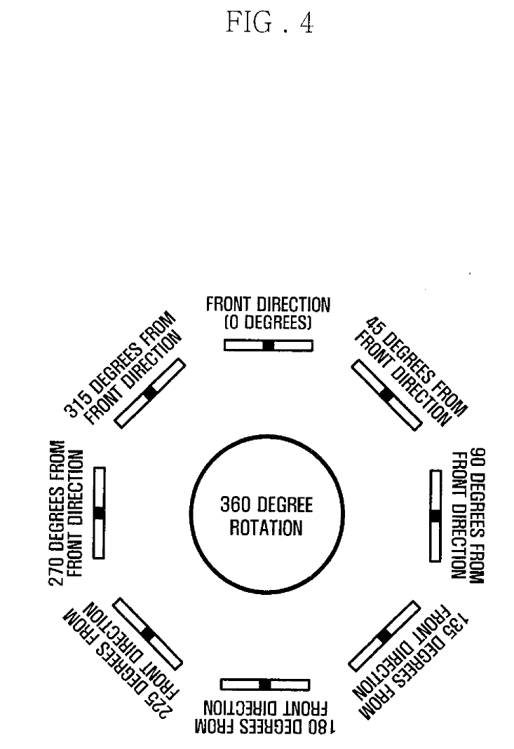

In addition, if an abnormality is determined to be present in the mobile robot 100, the control unit 200 may control the mobile robot 100 to stop or move to a preset location. The user may be able to retrieve the mobile robot, if the portion associated with motion is still functioning, or possibly have the mobile robot stop so as to prevent further or additional damage to the mobile robot. In other words, the control unit 200 can determine the abnormality of the wheel driving unit 101 and motor unit 102 through analysis of the difference between the reference image and comparison image captured by the camera unit 103. Thereafter, the control unit 200 can performs a series of steps to check the image capturing condition for the camera unit 103. These steps are described in detail later in connection with FIGS. 3 and 4. Thereafter, the control unit 200 can store the abnormality result in the memory unit 202, or send it to the remote control device. This feature may also permit additional or repeat self-diagnosis, and possibly further testing initiated via the remote control device.

The control unit 200 captures a comparison image after at least one of linear moves and rotational moves by a user specified amount, and determines the abnormality of the mobile robot.

The present invention is not limited by the exemplary configuration shown in FIG. 2. That is, the mobile robot 100 may further include various other elements for equivalent or additional functions according to the design. For example, the mobile robot 100 may further include a key input unit for manual manipulation of the robot, an audio unit for generating an alarm sound upon failure detection and for playing back various audio files, and a display unit for displaying various information. The mobile robot 100 may further include a power supply and battery for operation. The mobile robot 100 may further include a global positioning system (GPS) receiver to acquire information regarding the current location and direction.

FIG. 3 is a diagram illustrating an exemplary procedure for normality diagnosis on the linear motion of the wheel driving unit 101.

Referring now to FIGS. 1 and 3, for failure diagnosis on the linear motion of the wheel driving unit 101, upon reception of a self-diagnosis command issued by the user or programmed schedule, the control unit 200 examines the image capturing condition for the camera unit 103 to identify the abnormality of the mobile robot 100.

For example, the control unit 200 can check whether the current lighting level is high enough to permit taking distinguishable images, and whether the current location of the mobile robot 100 permits taking images in various directions or angles.

If the image capturing condition is determined to be satisfied, the control unit 200 controls the camera unit 103 to capture a reference image in a stationary state, and stores the reference image in the memory unit 202. Thereafter, the mobile robot 100 makes a forward or backward linear move by a preset distance.

After the linear move, the control unit 200 then controls the camera unit 103 to take a picture of a target object identical to that of the reference image, as a comparison image, and stores the comparison image in the memory unit 202.

The control unit 200 analyzes the difference between the comparison image and reference image captured by the camera unit 103. The control unit 200 then determines whether the analysis result is in accordance with corresponding reference data (i.e., whether the enlargement or reduction ratio of the target object corresponds to the reference data stored in the memory unit 202).

Specifically, for a forward linear move, the control unit 200 determines (using corresponding reference data stored in the memory unit 202) whether the comparison image captured after the move is enlarged relative to the reference image captured before the move by a given ratio.

Alternatively, for a backward linear move, the control unit 200 determines (using corresponding reference data stored in the memory unit 202) whether the comparison image captured after the move is reduced relative to the reference image captured before the move by a given ratio. If the difference is determined as not being in accordance with the reference data stored in the memory unit 202, the control unit 200 stores the discordance in the memory unit 202, creates a failure message indicating the malfunction of the linear motion of the wheel driving unit 101, and sends the failure message through the wireless unit 205 to the remote control device. The user can be made aware of the malfunction of the mobile robot 100 on the basis of the failure message received by the remote control device. Upon detection of a failure in the wheel driving unit 101, the control unit 200 may control the mobile robot 100 to stop or move to a preset location.

FIG. 4 is a diagram illustrating an exemplary procedure for normality diagnosis on the rotational motion of the wheel driving unit 101 and motor unit 102.

Referring to FIGS. 1 and 4, for failure diagnosis on the rotational motion of the wheel driving unit 101 and motor unit 102, a reference image is captured in the front direction and a comparison image is captured after rotation by 360 degrees. The control unit 200 checks whether the reference image and comparison image are identical to each other by computing a difference image therebetween. If the reference image and comparison image are identical to each other, the control unit 200 may preferably capture a reference image for each of eight directions (0, 45, 90, 135, 180, 225, 270 and 315 degree directions from the front direction), for further investigation. However, it should be noted that the present invention is not limited to these eight directions, either in number or the amount of degree between each image captured, as well as at what degree the images are captured. A person of ordinary skill in the art should appreciate that directions for capturing reference images can be varied according to the design.

After capturing the reference images at exemplary intervals such as shown in the example in FIG. 4, the control unit 200 controls the camera unit 103 to capture a comparison image for each corresponding reference image in the same or other direction.

When the captured direction of a comparison image is the same as that of the corresponding reference image, the control unit 200 checks the abnormality of the rotational motion of the wheel driving unit 101 and motor unit 102 through analysis of a difference image between the reference image and comparison image.

However, when the captured direction of a comparison image is different from that of the corresponding reference image, the control unit 200 checks the abnormality of the rotational motion of the wheel driving unit 101 and motor unit 102 by examining the adequacy of a change in the comparison image relative to the reference image using corresponding reference data stored in the memory unit 202. Thereafter, the control unit 200 can send a self-diagnosis message regarding the rotational motion of the wheel driving unit 101 and the motor unit 102 to the remote control device. The user can be made aware of the normality of the mobile robot 100 through the self-diagnosis message received by the remote control device. Upon detection of a rotational movement failure in the wheel driving unit 101 or motor unit 102, the control unit 200 may control the mobile robot 100 to stop or move to a preset location.

In the case when the rotation mechanism of the wheel driving unit 101 and motor unit 102 is permanently damaged, the diagnosis procedure for rotational motion described above may be not effective in detecting a rotational motion failure in the mobile robot 100. For example, it is assumed that the rotation mechanism of the wheel driving unit 101 or motor unit 102 is tilted to the left by 10 degrees because of permanent damage. The mobile robot 100 captures reference images in the eight directions as described above for self-diagnosis on rotational motion. These reference images are tilted to the left by 10 degrees. The mobile robot 100 then captures comparison images corresponding to the reference images in the same or other directions. Those comparison images taken in the same directions as corresponding reference images are also tilted to the left by 10 degrees. Hence, these comparison images are the same as the corresponding reference images. Consequently, the control unit 200 may be unable to detect an abnormality of the wheel driving unit 101 and motor unit 102 through analysis of a difference image between the reference image and comparison image.

To prevent the aforementioned scenario, it is preferable to store in the memory unit 202 reference images and their location and direction information that are captured when the rotation mechanism of the wheel driving unit 101 and motor unit 102 is in a normal state. In order to detect an abnormality of rotational motion caused by permanent damage, the control unit 200 controls the mobile robot 100 to move to a location at which a stored reference image was captured when the rotation mechanism of the wheel driving unit 101 and motor unit 102 was in a normal state, and controls the camera unit 103 to capture a comparison image in the same direction as the stored reference image. This reference image stored in the memory unit 202 is a normal image that is not tilted to the left by 10 degrees. The comparison image captured at the location where the reference image was captured is tilted to the left by 10 degrees. Hence, the control unit 200 is able to detect an abnormality of the wheel driving unit 101 and motor unit 102 through analysis of a difference image between the reference image and comparison image. Therefore, to detect a permanent failure occurring at the rotation mechanism of the wheel driving unit 101 and motor unit 102, it is preferable to store in the memory unit 202 reference images and their location information that are captured when the rotation mechanism is in a normal state.

Moreover, the present invention can also determine for example, if the reference images were captured on level ground, and the mobile robot might be situated on an inclining or declining terrain that may affect the tilt degree of the captured image. Thus, it may be preferable to have the mobile-robot determine via, for example, including but not limited in any way to sensors, laser sights, gyroscopic information, as to whether the robot is on flat or tilted ground, or to move to relatively flat ground to obtain images for reference or comparison.

Further, it is preferable to periodically perform self-diagnosis on the rotational motion of the wheel driving unit 101 and motor unit 102 at a location indicated by the location information stored in the memory unit 202.

If the motor unit 102 supports up/down motion, the self-diagnosis procedure for rotational motion described in connection with FIG. 4 may be applicable to the up/down motion of the motor unit 102. That is, because the up/down motion of the motor unit 102 can be regarded as a limited form of rotational motion, the self-diagnosis procedure for rotational motion described in connection with FIG. 4 may be used as a self-diagnosis procedure for the up/down motion.

When an abnormality is determined to be present in a driving unit through the self-diagnosis procedure described in connection with FIGS. 3 and 4, a failure message can be sent through the wireless unit 205 to the remote control device, and further a warning sound can be generated or a warning light can be turned on and off if the mobile robot 100 includes a speaker or a display unit of a light emitting diode (LED).

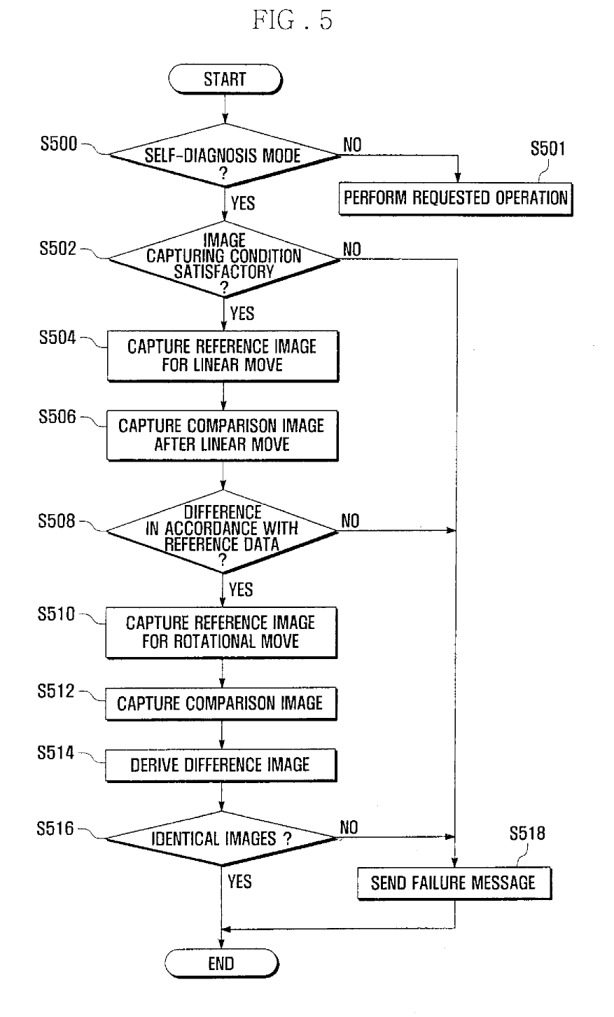

An artisan understands and appreciates that the remote control device may further contact a user via email, text message, telephone or radio transmission to a user's personal mobile communication device, so as to inform that a failure has occurred. It is also within the spirit and scope of the invention that the user's personal mobile device may comprise the remote device, or the remote device could be a module of the user's personal device, and the wireless unit might contact the user via a base station, using, for example CDMA. FIG. 5 is a flow chart illustrating an example of an image-based self-diagnosis method for a mobile robot according to another exemplary embodiment of the present invention.

Referring to FIG. 5, the control unit 200 of the mobile robot 100 checks whether the self-diagnosis mode is requested by the user or a programmed schedule (S500). If the self-diagnosis mode is not requested, the control unit 200 performs a requested operation (501). For example, if the mobile robot 100 is a cleaner, it may perform cleaning; and if the mobile robot 100 is a pet-dog robot, it may sleep, bark, or stroll depending upon the operation mode.

If the self-diagnosis mode is requested, the control unit 200 examines the image capturing condition for the camera unit 103 by checking whether the current lighting level is high enough to permit taking distinguishable images and by checking whether the current location permits taking images in various directions (S502).

If at step s502, the image capturing condition is not satisfied, the control unit 200 sends a failure message through the wireless unit 205 to the remote control device (S518), informing the user of the unsatisfactory image capturing condition. If the image capturing condition is satisfied, the control unit 200 controls the camera unit 103 to take a first reference image to be used for diagnosis on a linear motion of the wheel driving unit 101, and store the first reference image in the memory unit 202 (S504). The control unit 200 controls the mobile robot 100 to make a forward or backward linear move, and then controls the camera unit 103 to take a first comparison image and to store the first comparison image in the memory unit 202 (S506).

The control unit 200 analyzes the difference between the first reference image captured at step S504 and the first comparison image captured at step S506, and determines whether the analysis result is in accordance with corresponding reference data (S508).

Specifically, for a forward linear move, the control unit 200 determines whether the first comparison image captured at step S506 is enlarged relative to the first reference image captured at step S504 by a ratio preset in the corresponding reference data.

Alternatively, for a backward linear move, the control unit 200 determines whether the first comparison image captured at step S506 is reduced relative to the first reference image captured at step S504 by a ratio preset in the corresponding reference data.

At S508, if the difference is not in accordance with the reference data stored in the memory unit 202, the control unit 200 sends a failure message indicating the malfunction of the linear motion of the wheel driving unit 101 through the wireless unit 205 to the remote control device (S518), informing the user of the malfunction of the wheel driving unit 101.

However, at step s508, if the difference is in accordance with the reference data stored in the memory unit 202, the control unit 200 controls an operation to capture and store a second reference image for diagnosis on the rotational motion of the wheel driving unit 101 and motor unit 102 (S510). Therefrom, the control unit 200 controls the camera unit 103 to capture second reference images during a 360-degree rotation from the front direction and to store the second reference images in the memory unit 202. Because image capturing in all directions may impose a burden on the memory unit 202, it is preferable to capture second reference images at regular angular intervals.

After capturing the second reference images, the control unit 200 controls the camera unit 103 to capture a comparison image for each corresponding reference image in the same or other direction, and to store the second comparison images in the memory unit 202 (S512).

For pairs of a second reference image captured at step S510 and second comparison image captured at step S512, if the captured direction of the second comparison image is the same as that of the second reference image, the control unit 200 analyzes a difference image between the second reference image and comparison image (S514). For difference image analysis, the control unit 200 may use a smoothing algorithm stored in the memory unit 202 to remove a blob created at boundaries such as edges.

During analysis, if the pixels of the difference image having a value greater than a given threshold value exceed a preset ratio in number, the second reference image and second comparison image are determined to be different from each other. Otherwise, if the captured direction of the second comparison image is different from that of the second reference image, the control unit 200 checks whether a change in the second comparison image relative to the closest second reference image corresponds to the related reference data stored in the memory unit 202 to identify the abnormality of the rotational motion (S514). It should also be understood that this step could be repeated, for example, as something in the second image might change (for example, a person or a large vehicle might pass by as the image is captured), which could temporarily change the pixel values, so as to prevent a false failure indication. It should also be understood that the reference image might have had a temporary object that is not present in the comparison image, and a repeat might be required.

For all pairs of a second reference image and second comparison image, the control unit 200 determines whether the second reference image and second comparison image are the same (S516).

If the second reference image and second comparison image are the same or a change in the second comparison image corresponds to the related reference data, the control unit 200 determines that the wheel driving unit 101 and motor unit 102 are operating normally, and ends the self-diagnosis. If the second reference image and second comparison image are not the same or a change in the second comparison image does not correspond to the related reference data, the control unit 200 determines that the wheel driving unit 101 and motor unit 102 are not operating normally, and sends a failure message through the wireless unit 205 to the remote control device (S518), informing the user of the failure in the rotational motion of the wheel driving unit 101 and the motor unit 102 of the mobile robot 100.

As described before, to cope with the permanent damage of the rotation mechanism, which may make the diagnosis procedure ineffective in detecting a rotational motion failure, it is preferable to periodically perform self-diagnosis on the rotational motion at a location where a second reference image was captured when the wheel driving unit 101 and motor unit 102 were in a normal state. An image-based self-diagnosis method for a mobile robot further comprises acquiring and storing information regarding the current location and direction related to the captured reference image. The information regarding the current location and direction is obtained from a global positioning system (GPS).

For more accurate diagnosis on the rotational motion by reducing the number of variables to be considered, it is preferable to separately diagnose the wheel driving unit 101 and motor unit 102.

In the flow chart of FIG. 5, the linear motion is first diagnosed and then the rotational motion is diagnosed. However, the linear motion and rotational motion may be simultaneously diagnosed, or the rotational motion may be first diagnosed and then the linear motion be diagnosed.

While exemplary embodiments of the present invention have been shown and described in this specification, it will be understood by those skilled in the art that various changes or modifications of the embodiments are possible without departing from the spirit and scope of the invention as defined by the appended claims.

For example, the number of comparison or reference images, the amount of angular or linear rotation, method of image comparison, etc., may be modified but still lie within the scope of the appended claims. Also, as discussed herein, transmitting by the wireless unit may include transmission to a remote device via base station, or via WiFi network, etc. While there is a disclosure that a speaker generates a warning sound, any type of transducer may be used (piezoelectric, electro restrictive, for example) that may generate a vibration, and the wireless unit may signal a remote user device to vibrate, output an audible tone, or even a temperature change in the remote device in lieu of or in addition warnings directly audible or visible, etc. from being within close proximity to the mobile robot.

What is claimed is:

1. An image-based self-diagnosis apparatus for a mobile robot, comprising:
a driving unit making a linear move and rotational move;
a camera unit capturing visual images;
a memory unit storing visual images captured by the camera unit; and
a control unit capturing a reference image at a current location through the camera unit, capturing a comparison image after controlling the driving unit to make at least one of linear moves and rotational moves by a preset amount, storing the captured reference and comparison images in the memory unit, and determining the abnormality of the mobile robot by comparing the stored reference image captured before the moves and the comparison image captured after the moves.

2. The image-based self-diagnosis apparatus of claim 1, wherein the control unit captures a comparison image after controlling the driving unit to make at least one of linear moves and rotational moves by a user specified amount, and determines the abnormality of the mobile robot.

3. The image-based self-diagnosis apparatus of claim 1, wherein the memory unit further stores reference data indicating the degree of change of a reference image.

4. The image-based self-diagnosis apparatus of claim 1, further comprising a global positioning system (GPS) receiver to acquire information regarding the current location and direction.

5. The image-based self-diagnosis apparatus of claim 4, wherein the memory unit further stores information regarding the current location and direction.

6. The image-based self-diagnosis apparatus of claim 3, wherein the control unit determines the abnormality of the mobile robot for linear motion by checking whether an enlargement or reduction ratio of the reference image is in accordance with the stored reference data.

7. The image-based self-diagnosis apparatus of claim 3, wherein the control unit determines the abnormality of the mobile robot for rotational motion by checking whether one or more comparison images taken at regular angular intervals match corresponding reference images taken in advance.

8. The image-based self-diagnosis apparatus of claim 3, wherein the control unit determines the abnormality of the mobile robot for rotational motion by checking whether a change in a comparison image taken after a rotation by a preset angle is in accordance with the stored reference data.

9. The image-based self-diagnosis apparatus of claim 1, wherein the control unit checks the current lighting level and the current location of the camera unit before taking a reference image or comparison image to determine adequacy of photographing, and moves, when the current lighting level and the current location are not adequate for taking the reference image or comparison image, the mobile robot to another location.

10. The image-based self-diagnosis apparatus of claim 1, further comprising at least one of:
a speaker generating a warning upon failure detection; and
a light-emitting diode (LED) turning on and off a warning light upon failure detection.

11. The image-based self-diagnosis apparatus of claim 1, further comprising a wireless unit sending a message indicating presence or absence of a failure to a remote control device.

12. The image-based self-diagnosis apparatus of claim 11, wherein the remote control device is one of a mobile communication terminal, smart phone, computer, network server, and personal digital assistant.

13. An image-based self-diagnosis method for a mobile robot, comprising:
capturing a reference image at the current location and storing the captured reference image;
capturing a comparison image after making at least one of linear moves and rotational moves by a preset amount, and storing the captured comparison image; and
determining the abnormality of the mobile robot by comparing the stored reference image and the comparison image with each other.

14. The image-based self-diagnosis method of claim 13, wherein capturing a reference image comprises capturing a comparison image after making at least one of linear moves and rotational moves by a user specified amount and storing the captured reference image.

15. The image-based self-diagnosis method of claim 13, further comprising checking possibility of taking a reference image or comparison image with acceptable quality.

16. The image-based self-diagnosis method of claim 15, wherein checking possibility of taking a reference image or comparison image comprises:
checking whether the current lighting level is high enough to permit taking distinguishable images;
checking whether the current location permits taking images in various directions; and
moving, when the current lighting level or the current location is inadequate for taking a reference image or comparison image, the mobile robot to a different location.

17. The image-based self-diagnosis method of claim 13, wherein capturing a reference image further comprises acquiring and storing information regarding the current location and direction related to the captured reference image.

18. The image-based self-diagnosis method of claim 17, wherein the information regarding the current location and direction is obtained from a global positioning system (GPS).

19. The image-based self-diagnosis method of claim 13, wherein determining the abnormality of the mobile robot comprises checking, for linear motion, whether an enlargement or reduction ratio of the reference image is in accordance with pre-stored reference data.

20. The image-based self-diagnosis method of claim 13, wherein determining the abnormality of the mobile robot comprises checking, for rotational motion, whether one or more comparison images taken at regular angular intervals match corresponding reference images taken in advance.

21. The image-based self-diagnosis method of claim 13, wherein determining the abnormality of the mobile robot comprises checking, for rotational motion, whether a change in a comparison image taken after a rotation by a preset angle is in accordance with pre-stored reference data.

22. The image-based self-diagnosis method of claim 13, wherein determining the abnormality of the mobile robot comprises at least one of:
generating a warning upon failure detection; and
turning on and off a warning light upon failure detection.

23. The image-based self-diagnosis method of claim 13, further comprising sending a message indicating presence or absence of a failure to a remote control device.

24. The image-based self-diagnosis method of claim 23, wherein the remote control device is one of a mobile communication terminal, smart phone, computer, network server, and personal digital assistant.
